(19) United States
(12) Patent Application Publication
(10) Pub. No.: US 2024/0106246 A1
(43) Pub. Date: Mar. 28, 2024

(54) POWER STORAGE DEVICE AND METHOD FOR DISCHARGING THE SAME

(71) Applicant: Gogoro Inc., Hong Kong (CN)

(72) Inventors: Wei-Tsung Huang, Taoyuan City (TW); I-Sheng Chen, Taoyuan City (TW); Liang-Yi Hsu, Taoyuan City (TW)

(21) Appl. No.: 18/475,744

(22) Filed: Sep. 27, 2023

Related U.S. Application Data
(60) Provisional application No. 63/377,411, filed on Sep. 28, 2022.

(51) Int. Cl. H02J 7/00

(52) U.S. Cl. CPC H02J 7/00045; H02J 7/0063

(57) ABSTRACT

Disclosed is a power storage device and method for discharging the same, which configures the power storage device to perform an electric power output under a discharging limit upon coupling with a load device and before any authentication is conducted. The discharging limit for the electric power output will be lifted only when an authentication result between the power storage device and the load device indicates a successful authentication.

### CROSS-REFERENCE TO RELATED APPLICATION

This application claims priority to U.S. Provisional Application Ser. No. 63/377,411, filed Sep. 28, 2022, which is herein incorporated by reference in its entirety.

### BACKGROUND

### Field of Invention

The present disclosure relates to a power storage device and a method for discharging the same.

### Description of Related Art

Among various types of equipment products driven by electric power, those using portable and rechargeable power storage device (e.g., storage batteries, supercapacitors or ultracapacitors) rather than relying on utility power charging as main power source are especially of great developmental potential. While applicable range of such equipment products has grown diverse, in order to ensure their certain level of operation (e.g., communication with external devices or power storage devices) by internal electronic components during power-off (e.g., during inactive state, and exhaustion or swapping of power storage devise for the equipment products), a backup battery (e.g., lead-acid battery) is usually disposed additionally to provide fundamental electric power for keeping these internal electronic components in awake state and support operation when the equipment products is not powered on.

However, due to different requirements for usage of power storage devices, situations where the above-mentioned equipment products are incapable of disposing or in need of omitting backup batteries may occur under considerations such as fabrication costs and structural arrangement difficulties. These situations (or situations where backup batteries of equipment products are damaged) will all result the internal electronic components fail to stay operative during power-off of the equipment products.

Therefore, one of the urgent needs for the current industry is how to propose a power storage device and a method for discharging the same and solve the above problems.

### SUMMARY

For achieving the objectives discussed above, a power storage device is disclosed. The power storage device includes a power storage unit configured to store electric power; an electrical connection unit, configured to be electrically connected with the power storage unit and coupled with a load device; and a device management unit electrically connected with the power storage unit and configured to: detect a connection event regarding coupling of the electrical connection unit with another electrical connection unit on the load device; in response to the connection event, output the electric power to the load device through the electrical connection unit under a discharging limit; and confirm an authentication result between the power storage device and the load device during output of the electric power under the discharging limit.

In some embodiments, the device management unit is further configured to: lift the discharging limit for output of the electric power if the authentication result indicates to be successful authentication.

In some embodiments, the device management unit is further configured to: prohibit output of the electric power to the load device if the authentication result indicates to be failed authentication.

In some embodiments, a means for the device management unit confirming the authentication result indicates to be failed authentication comprises confirming the device management unit failing to receive the authentication result within a time limit confined by the discharging limit, and wherein the time limit confines the electric power to be output in a time period less than or equal to 15 seconds.

In some embodiments, the discharging limit confines the electric power of the power storage unit to be output at a power value less than or equal to one-twentieth of a maximum output power value of the power storage device; or the discharging limit confines the electric power of the power storage unit to be output at a current value less than or equal to one-twentieth of a maximum output current value of the power storage device.

In some embodiments, the authentication result is reported back to the device management unit by a bridge control unit, and the bridge control unit is on the load device and is electrically connected with another electrical connection unit.

In some embodiments, a means for the device management unit confirming the authentication result indicates to be failed authentication comprises one or more of following conditions: the bridge control unit fails to verify a first authentication information from the device management unit; the device management unit fails to verify a second authentication information from the bridge control unit; the bridge control unit fails to verify a third authentication information from a load control unit of the load device; the load control unit fails to verify a fourth authentication information from the device management unit; and the device management unit fails to verify a fifth authentication information from the load control unit.

A method for discharging a power storage device is also disclosed. The method includes: detecting a connection event regarding coupling of the power storage device with a load device; in response to the connection event, enabling the power storage device to conduct an electric power output to the load device under a discharging limit; and confirming an authentication result between the load device and the power storage device during the electric power output under the discharging limit by the power storage device.

In some embodiments, the method further includes: if the authentication result indicates to be successful authentication, lifting the discharging limit of the electric power output by the power storage device.

In some embodiments, the method further includes: if the authentication result indicates to be failed authentication, prohibiting the electric power output by the power storage device.

In some embodiments, a means for confirming the authentication result indicates to be failed authentication comprises confirming the power storage device failing to receive the authentication result within a time limit confined by the discharging limit, and the time limit confines a time for the electric power output to be less than or equal to 15 seconds.

In some embodiments, the discharging limit confines a power value of the electric power output to be less than or equal to one-twentieth of a maximum output power value of the power storage device; or the discharging limit confines a current value of the electric power output to be less than or equal to one-twentieth of a maximum output current value of the power storage device.

In some embodiments, the authentication result is reported back to the power storage device by a bridge device, and the bridge device is electrically connected to the load device.

In some embodiments, a means for confirming the authentication result indicates to be failed authentication comprises one or more of following conditions: the bridge device fails to verify a first authentication information from the power storage device; the power storage device fails to verify a second authentication information from the bridge device; the bridge device fails to verify a third authentication information from the load device; the power storage device fails to verify a fourth authentication information from the load device; and the load device fails to verify a fifth authentication information from the power storage device.

In some embodiments, detecting the connection event regarding the power storage device coupling with the load device comprises: sensing a closed-circuit condition of an electrical connection between the power storage device and the load device.

In some embodiments, the method further includes: confirming an electrically supplied state of the load device; and if the electrically supplied state indicates to be supplied with electric power, enabling the power storage device to confirm the authentication free from the discharging limit.

Based on the above description, the power storage device and the method for discharging the same according to the present invention precondition the power storage device to conduct electric power output under a discharging limit for a control unit on a load device, and only lifts the discharging limit when the authentication(s) between the power storage device and the load device indicates successful. Therefore, if the load device is configured without a backup battery or with a damaged backup battery, the operation of the load control unit can be maintained through the electric power under the discharging limit, thereby achieve mutual authentication with the power storage device, and prevent damage caused to the load device when bearing excessive electric power upon connected to the power storage device.

### BRIEF DESCRIPTION OF THE DRAWINGS

Aspects of the present invention are best understood from the following detailed description when read with the accompanying drawings. It should be noted that the sizes and relative positions of elements in the drawings are not necessarily drawn to scale, and some of these elements have been arbitrarily enlarged and positioned to improve drawing clarity. Furthermore, specific shapes of elements as drawn are not intended to convey any information about the actual shape of the particular element and are chosen merely for identification in the drawings.

FIG. 1 is a schematic diagram of components of a system according to some embodiments of the present invention.

FIG. 2 is a flowchart of steps of a method for discharging a power storage device according to some embodiments of the present invention.

FIG. 3A to FIG. 3E are diagrams illustrating implementation aspects of each step in FIG. 2.

FIG. 4 is a flow chart of detailed steps in FIG. 2.

FIG. 5 is a flow chart of detailed steps in FIG. 2.

### DETAILED DESCRIPTION

Embodiments of the present invention will be described below in accompany with related drawings, and some specific details will be set forth in order to provide a thorough understanding of various disclosed embodiments. One skilled in the art will recognize, however, that the embodiments may be practiced without one or more of these specific details, or with other methods, components, materials, and the like. In the drawings, the same reference numerals indicate the same or similar elements or method flow.

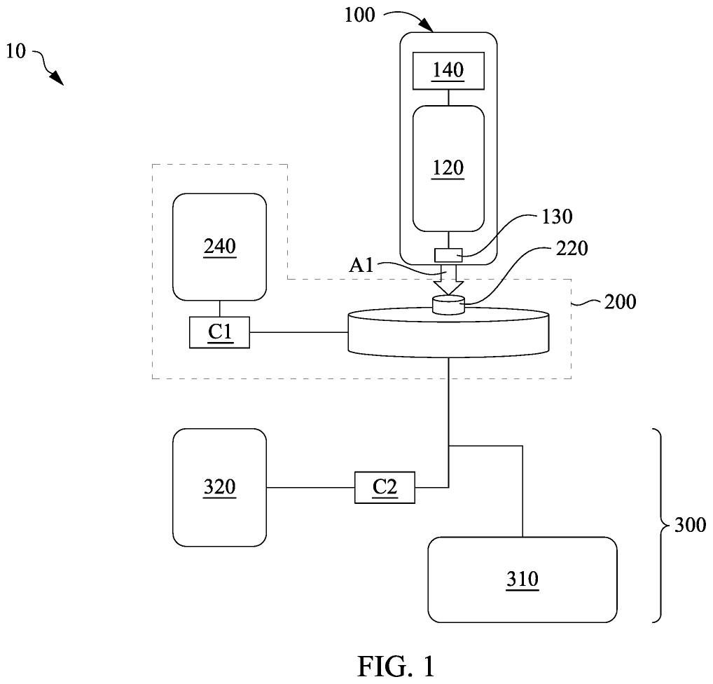

FIG. 1 is a schematic diagram of components of a system 10 of the present invention. In the present embodiment, the system 10 mainly includes a power storage device 100, a bridge device 200, and a load device 300. Specifically, the load device 300 is an equipment product driven by electric power; the power storage device 100 is configured to provide the electric power to the load device 300 and enable operation of the load device 300; and the bridge device 200 is electrically connected to the load device 300 and configured to allow the power storage device 100 detachably coupled (e.g., connected along a direction indicated by the arrow A1) to the load device 300. From the configuration of said system 10, it can be understood that the bridge device 200 in the system 10 provides a bridging path between the power storage device 100 and the load device 300, of which the electric power of the power storage device 100 is transmitted to the load device 300 through the bridging path.

In some embodiments, the load device 300 is an electric vehicle, and the power storage device 100 is a battery pack, in particular an exchangeable battery pack. The load device 300 is formed with an accommodating space (not depicted), where the bridge device 200 is installed at the bottom of the accommodating space and is electrically connected with the load component(s) 310 and the load control unit 320 of the load device 300. Furthermore, the power storage device 100 is configured to be arranged in the accommodating space and supply electric power to the load component(s) 310 and the load control unit 320 of the load device 300 through the bridge device 200.

In some embodiments, in addition to providing the bridging path between the power storage device 100 and the load device 300, the bridge device 200 can be further configured to conduct authentication for the power storage device 100 and/or the load device 300. For example, the bridge device 200 may conduct authentication for the power storage device 100 to verify that the power storage device 100 is a battery pack authorized to supply electric power to the correspondingly authorized load device 300. In another example, the bridge device 200 may also conduct an authentication for the load device 300 to verify that the load device 300 is an electric vehicle authorized to receive electric power from the correspondingly authorized power storage device 100. In some embodiments, only when the authentication between the bridge device 200 and the power storage device 100 and the authentication between the bridge device 200 and the load device 300 both indicated successful will the bridge device 200 transmit the electric power of the power storage device 100 to the load device 300. In some other embodiments, if either the authentication between the bridge device 200 and the power storage device 100 or the authentication between the bridge device 200 and the load device 300 indicates a failure, the power storage device 100 will not supply electric power to the load device 300.

In some alternative embodiments, the load device 300 can also be other equipment products electrically driven by the power storage device 100. Said other equipment products include, but not limited to, products such as intelligent parking bollards using the power storage device 100 as power source, smart signal lights using the power storage device 100 as uninterruptible power supply, and battery swap stations, or equipment products omitting backup batteries, such as micro-electric vehicles, light vehicles, electric mechanical or agricultural tools, and battery chargers.

In some embodiments, the power storage device 100 and the bridge device 200 are respectively configured with electrical connection units 130 and 220, which can be male and female parts (e.g., plugs and sockets) used for establishing an electrical connection between the power storage device 100 and the bridge device 200 (and subsequently, the load device 300). The bridge device 200 is configured to conduct authentication for the power storage device 100 and/or the load device 300 in response to a connection event where the electrical connection units 130 and 220 are coupled to each other and form an electrical connection. In some embodiments, the bridge device 200 can be configured to receive authentication information from the power storage device 100 and/or the load device 300 and perform verification thereto; and in some other embodiments, the bridge device 200 can receive the authentication information by utilizing a physical connection with the power storage device 100 and/or the load device 300.

In some embodiments, the power storage device 100 includes a device management unit 140, which is electrically connected to the power storage unit 120 within the power storage device 100; the bridge device 200 includes a bridge control unit 240, which is electrically connected to the electrical connection unit 220; and the load device 300 includes a load control unit 320, which communicates with the load component(s) 310 to conduct management and control during operation of the load device 300. In some embodiments, the bridge device 200 conducts said authentication by utilizing the bridge control unit 240 to communicate with the device management unit 140 and/or the load control unit 320. In here, the bridge control unit 240, the device management unit 140 and the load control unit 320 may be provided with essential electronic components to enable authentication, such as processors, storage components, communication interfaces, etc. In the embodiment where the load device 300 is an electric vehicle and the power storage device 100 is a battery pack, the device management unit 140 is a battery management system (BMS); the power storage unit 120 is one or more battery cell; the load control unit 320 is an electronic control unit (ECU) or a vehicle control unit (VCU) of the electric vehicle; and the load components 310 are components within the electric vehicle to the likes of an electric motor, an instrument assembly, a motor controller, etc.

In some embodiments, the communication between the bridge control unit 240 and the device management unit 140 and/or the load control unit 320 can be realized through suitable wireless communication or wired communication. Preferably, the wireless communication refers to Near Field Communication (NFC) or Radio Frequency Identification (RFID), but can also be Bluetooth, ZigBee, ultra-wideband, low-power Bluetooth and/or other communication measures. Of course, the present invention should not be limited thereto. Alternatively, wired communication may refer to a physical connection between the bridge control unit 240, the device management unit 140 and/or the load control unit 320 for information transfer.

In some embodiments, the authentication between the bridge control unit 240 and the device management unit 140 is a two-way authentication. In other words, in addition to the authentication conducted by the bridge control unit 240 for the device management unit 140, the device management unit 140 is also configured to conduct authentication for the bridge device 200 to verify that the bridge device 200 is a device authorized to transfer the electric power of the correspondingly authorized power storage device 100 to the load device 300. In here, the device management unit 140 communicates with the bridge control unit 240 and receives the authentication information regarding the bridge device 200 or the load device 300 from the bridge control unit 240 and verifies thereto, thereby completing the two-way authentication. In some embodiments, if the bridge control unit 240 fails to pass the authentication (i.e., the bridge device 200 is not a device authorized to couple with the power storage device 100), the device management unit 140 will prohibit the power storage device 100 to output electric power.

In some embodiments, the bridge control unit 240 is configured to report (e.g., send a notification message) result of the authentication conducted for the load control unit 320 back to the device management unit 140. Specifically, in situation where the authentication conducted for the load control unit 320 by the bridge control unit 240 indicates failure (i.e., the load device 300 is an unauthorized equipment product), the device management unit 140 will prohibit the power storage device 100 to output electric power according to the result reported back by the bridge control unit 240.

In some embodiments, the power storage device 100 is configured to conduct an electric power output under a discharging limit upon coupling with the bridge device 200 and before any authentication is conducted by arbitrary components within the system 10. This electric power output under the discharging limit is to supply electric power to the bridge control unit 240 of the bridge device 200 and the load control unit 320 of the load device 300, so as to wake up the bridge control unit 240 and the load control unit 320 for conducting the aforementioned authentication. In situation where authentication(s) among the device management unit 140, the bridge control unit 240, and the load control unit 320 all indicate successful (i.e., the power storage device 100, the bridge device 200 and the load device 300 are all authorized devices), the device management unit 140 then lifts the discharging limit and adjust the electric power output of the power storage device 100 to normal discharge (i.e., the power storage device 100 can start to supply electric power to other load components 310 of the load device 300 under its range for electric power output without limitation). On the other hand, for a situation where said authentication(s) indicate failure, the device management unit 140 will prohibit the power storage device 100 to output electric power.

In other words, authentications among the power storage device 100, the bridge device 200 and the load device 300 must be completed before the power storage device 100 is allowed to supply electric power to the load device 300 normally. However, in this scenario, the bridge control unit 240 and the load control unit 320 need to acquire electric power to conduct said authentications before the power storage device 100 discharges normally. Therefore, the electric power output under the discharging limit conducted by the power storage device 100 is configured at a level sufficient to support operations of the bridge control unit 240 and the load control unit 320 in advance. With this configuration, the bridge control unit 240 and the load control unit 320 do not need to rely on an additional backup battery to maintain the operation thereof before the power storage device 100 discharges normally (i.e., during the load device 300 is powered off). Further, compared to directly subjecting the load device 300 to the electric power from normal discharge of the power storage device 100, this configuration can also protect the load component 310 from damaged usage life induced by bearing a relatively large electric power instantly.

Specifically, the aforementioned electric power output under discharging limit by the power storage device 100 may be confined to one or more of the conditions below: an electric power output under a power limit; an electric power output under a current limit; or an electric power output under a time limit. In preferred embodiments, if the authentications among the power storage device 100, the bridge device 200, and the load device 300 failed to complete within the time limit of the discharging limit (i.e., the authentications failed), the device management unit 140 then prohibits electric power output of the power storage device 100. In other optional embodiments, the electric power output under the power limit or the current limit may also be supplied to the load components 310 of the load device 300, but the electric power output under this condition is not sufficient to enable operation of the load components 310, and the electric power output by the power storage device 100 will be prohibited by the device management unit 140 when the bridge control unit 240 reports authentication failure for the power storage device 100 and/or the load device 300 to the device management unit 140, or when the device management unit 140 has determined authentication failure for the bridge device 200.

More specifically, said electric power output under the power limit refers to adjusting the output power value to be less than or equal to one-twentieth (five percent) of the maximum output power value of the power storage device 100; the electric power output under the current limit refers to adjusting the output current value to be less than or equal to one-twentieth (five percent) of the maximum output current value of the power storage device 100; and the electric power output under the time limit refers to confining the electric power to be output in a time period greater than 0 second and less than or equal to 15 seconds. The maximum output power value and the maximum output current value described herein refer to the maximum physical quantity for electric power being provided externally by the power storage device 100 per unit time during a normal discharge. For example, for a battery pack used in an electric vehicle, the maximum output power value can be 5000 Watt (W), and the maximum output current value can be 250 Amperes (A). However, according to variance in electricity supply applications for the power storage device 100, physical quantities for normal discharge may be configured differently. For example, the maximum output power value and the maximum output current value of the power storage device 100 may be 1000 W and 20 A, respectively.

For example, the electric power output under the discharging limit conducted by the power storage device 100 refers to the following: in situation where the maximum output power value can reach 5000 W and the maximum output current value can reach 100 A for the power storage device 100 under normal discharge, the power storage device 100 is configured to conduct an electric power output under a discharging limit that lasts for 15 seconds (or less), has a power value of 250 W (or less) and has an current value of 5 A (or less) upon coupling with the bridge device 200 and before any authentication is conducted by arbitrary components within the system 10. On this basis, authentications among the power storage device 100, the bridge device 200, and the load device 300 must be completed during the period of the electric power output under this discharging limit, or else subsequent electric power output of the power storage device 100 will be prohibited by the device management unit 140. It should be noted that the various limitations as mentioned above can be configured as other applicable values depending on requirements for the device management unit 140, the bridge control unit 240 and/or the load control unit 320 to complete the authentication, and other types of discharging limits can be also introduced, of which the present invention is not limited thereto.

In some embodiments, the device management unit 140 can be configured with a switch 142 that is toggled between an ON state and an OFF state. When the switch 142 is toggled to ON state, the power storage device 100 is allowed to discharge; and when the switch 142 is toggled to OFF state, the power storage device 100 is prohibited to discharge. For example, the switch 142 can be toggled to the ON state by the device management unit 140 in response to the power storage device 100 coupling with the bridge device 200, and enable the power storage device 100 conduct the aforementioned electric power output under the discharging limit to supply electric power to the bridge control unit 240 and the load control unit 320. In the above situation, the device management unit 140 will keep the switch 142 at ON state and lift the discharging limit when the authentications among the power storage device 100, the bridge device 200 and the load device 300 are determined as successful, thereby enable adjustments of the electric power output of the power storage device 100 to normal discharge (i.e., the electric power being output will not be limited by the power value and/or the current value confined by the discharging limit) that is sufficient to supply the operation of the entire system 10 (including the load components 310). On the contrary, in situation where the above authentications indicate failure, the device management unit 140 will toggle the switch 142 to OFF state and prohibit the power storage device 100 to discharge.

In some alternative embodiments, the bridge device 200 may be a non-independent component that is integrated with the load device 300, that is, the system 10 is not configured with the bridge device 200. In here, the load device 300 can be configured to: include the electrical connection unit 220 and provide a bridging path for receiving the electric power provided by the power storage device 100; and integrate the bridge control unit 240 as the load control unit 320 of the load device 300, which is configured to additionally conduct, when the electrical connection unit 130 of the power storage device 100 is coupled to the electrical connection unit 220, the aforementioned tasks of the bridge control unit 240 such as verifying authentication information of the device management unit 140, providing authentication information to the device management unit 140 for verification, reporting authentication result, etc.

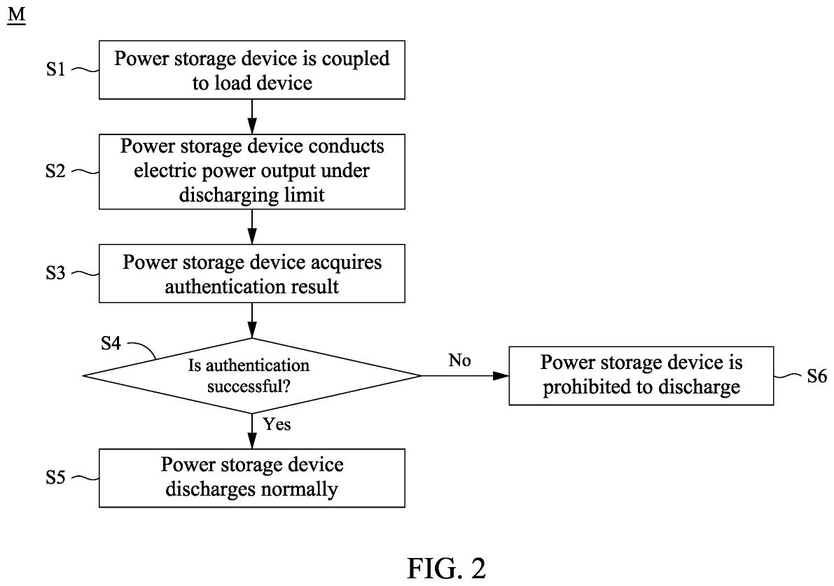

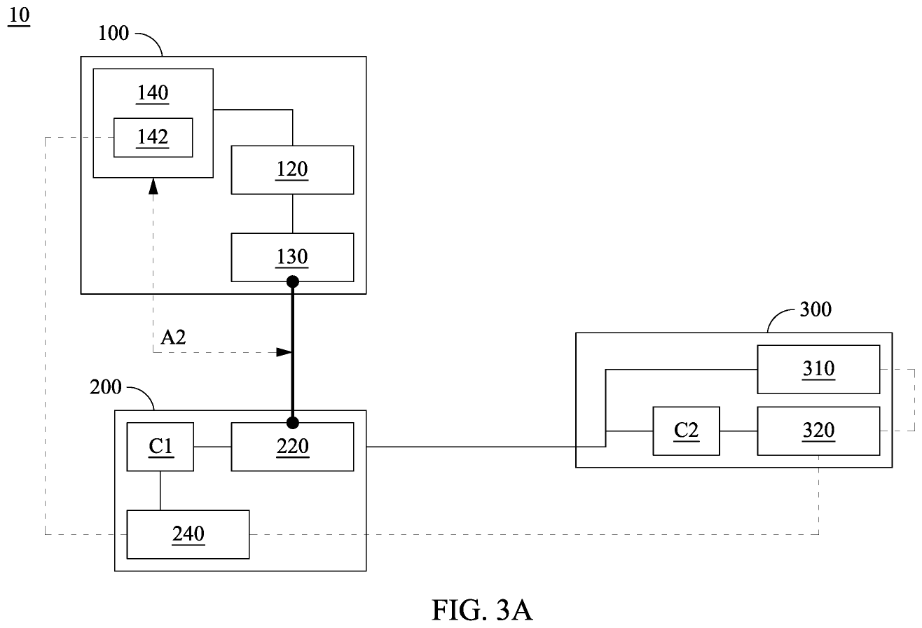

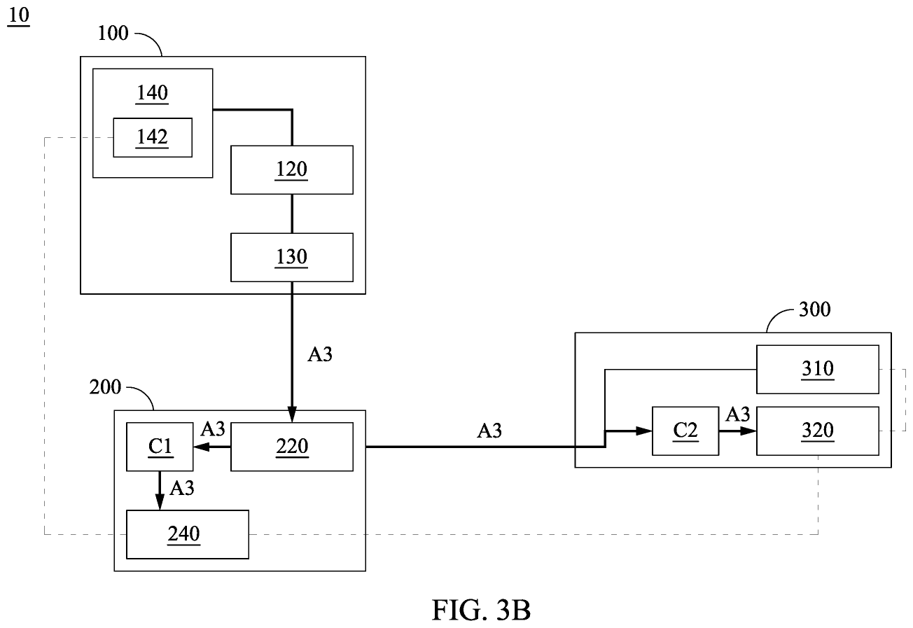

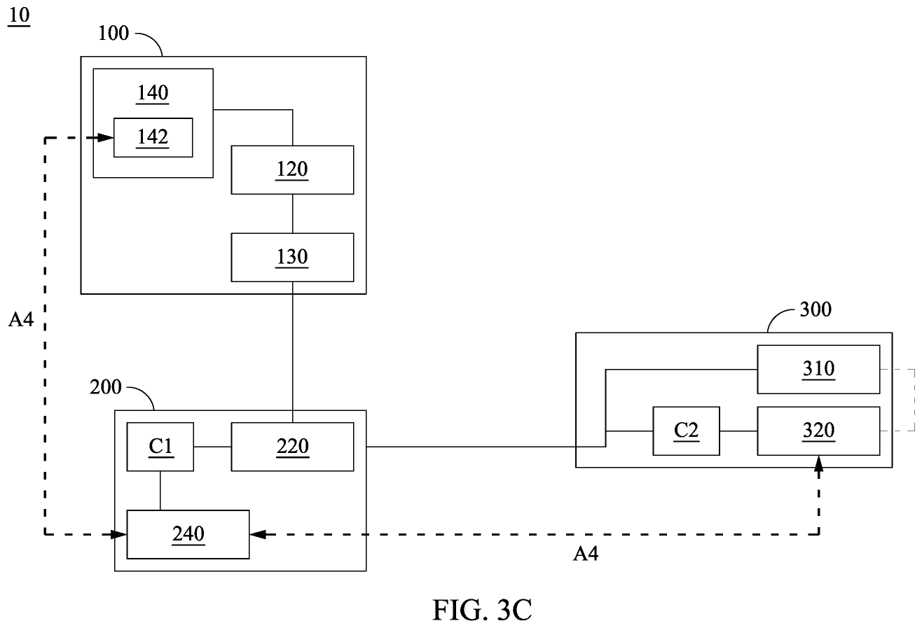

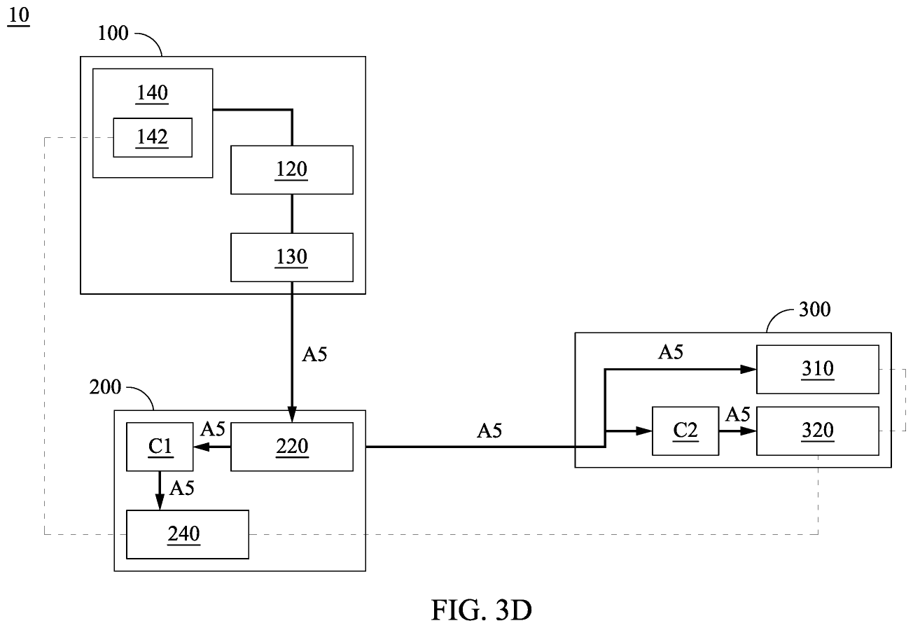

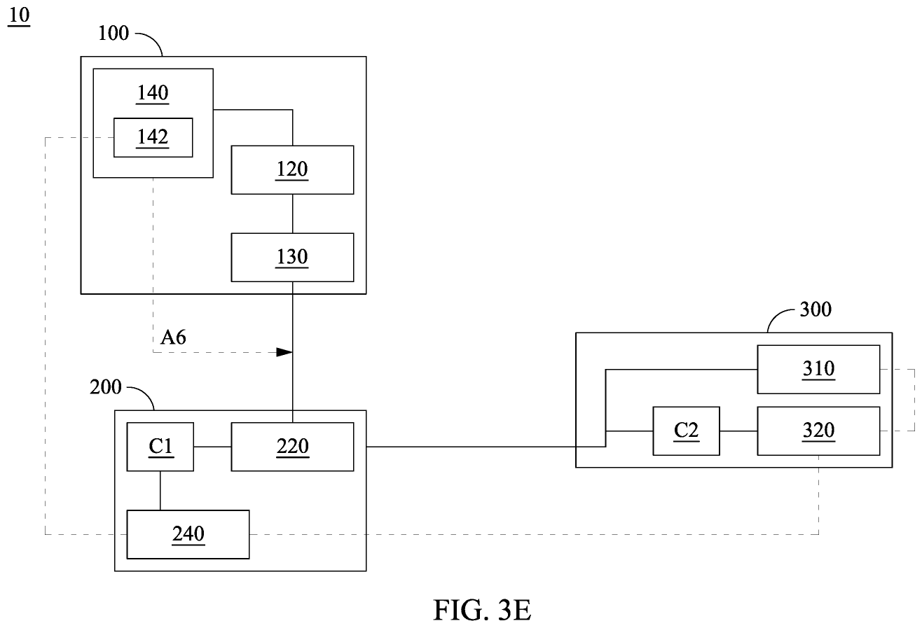

FIG. 2 is a flowchart for steps of a method M according to some embodiments of the present invention. FIGS. 3A to 3E exemplarily illustrates operation status of respective components of the system 10 during the corresponding steps of the method M, in which the solid lines indicate delivery paths for electric power, and the dashed lines indicate transmission paths for signals. Specifically, the method for discharging the power storage device 100 in the present invention mainly includes steps S1 to S6.

Reference may be made to FIG. 3A, where step S1 describes detecting an event where the power storage device 100 is coupled to the load device 300. The event in particular refers to a connection event where the electrical connection units 130 and 220 being coupled to each other when the power storage device 100 is mounted on the bridge device 200. In preferred embodiments, said connection event is detected by the device management unit 140. As indicated by arrow A2, the device management unit 140 can determine the connection event by sensing a closed-circuit condition of the electrical connection between the power storage device 100 and the bridge device 200 (and subsequently, the load device 300) established by the coupling between the electrical connection units 130 and 220. In alternative embodiments, one or more sensing components disposed in the power storage device 100 and/or on the bridge device 200 or the load device 300 can be utilized for sensing and reporting the connection event to the device management unit 140. For example, the sensing components can be positioned to be in contact with the power storage device 100 when the power storage device 100 is coupled to the load device 300, and configured to report the connection event when abutting the power storage device 100.

Reference can be made to FIG. 3B, where step S2 describes enabling the power storage device 100 to conduct an electric power output under a discharging limit. The electric power output under the discharging limit in particular refers to having the power storage device 100 provide electric power merely sufficient for operation of the bridge control unit 240 and the load control unit 320. As indicated by arrow A3, in response to the connection event sensed in step S1, the device management unit 140 will impel (e.g., toggle the switch 142 to ON state) the power storage device 100 to output the electric power stored in the power storage unit 120 under the discharging limit to the bridge device 200 and the load device 300 through the electrical connection unit 130. This electric power output under the discharging limit will be used to wake up the bridge control unit 240 and the load control unit 320 for conducting the authentication in step S3.

In some embodiments, the path for electric power output under the discharging limit conducted by the power storage device 100 at step S2 may include electric energy converters C1 and C2, which are respectively used to convert electric power into physical characteristics suitable for operations of the electrically connected bridge control unit 240 and load control unit 320. Specifically, the electric energy converters C1 and C2 may be DC-DC converters, where the electric energy converter C1 is used to convert the 48-volt (V) direct current provided by the power storage device 100 into a 12 V direct current for supplying operation of the bridge control unit 240, and the electric energy converter C2 is used to convert the 48 V direct current provided by the power storage device 100 into direct current of a suitable low electric potential (such as a direct current of 20 V or below) for supplying operation of the load control unit 320. It should be understood that there may exist other electric energy converters in response to operation requirements of respective components in the system 10 to supply operation of other components within the bridge device 200 or the load device 300, or there may be no electric energy converters, of which the present invention is not limited thereto.

Reference can be made to FIG. 3C, where step S3 describes confirming acquisition for the authentication result at the power storage device 100 regarding the authentications conducted among the power storage device 100, the bridge device 200 and/or the load device 300. The authentication result in particular refers to the result confirmed by the device management unit 140 that is reported (e.g., having the bridge control unit 240 to send a notification message to the device management unit 140) after authentication during the electric power output under the discharging limit by the power storage device 100 is conducted. As indicated by arrow A4, conducting of authentication may refer to: having the bridge control unit 240 to communicate with the load control unit 320 and verify that the load device 300 is an equipment product authorized to receive electric power from the power storage device 100; having the bridge control unit 240 to communicate with the device management unit 140 and verify that the power storage device 100 is an authorized device to supply electricity to the load device 300; and/or having the device management unit 140 to communicate with the bridge control unit 240 and verify that the bridge device 200 is an authorized device to transfer the electric power of the power storage device 100. Alternatively, if the system 10 is not configured with the bridge device 200 (e.g., the bridge device 200 is integrated with the load device 300), conducting of authentication may refer to one-way or two-way authentication between the load control unit 320 and the device management unit 140, of which the details thereof are not repeated herein.

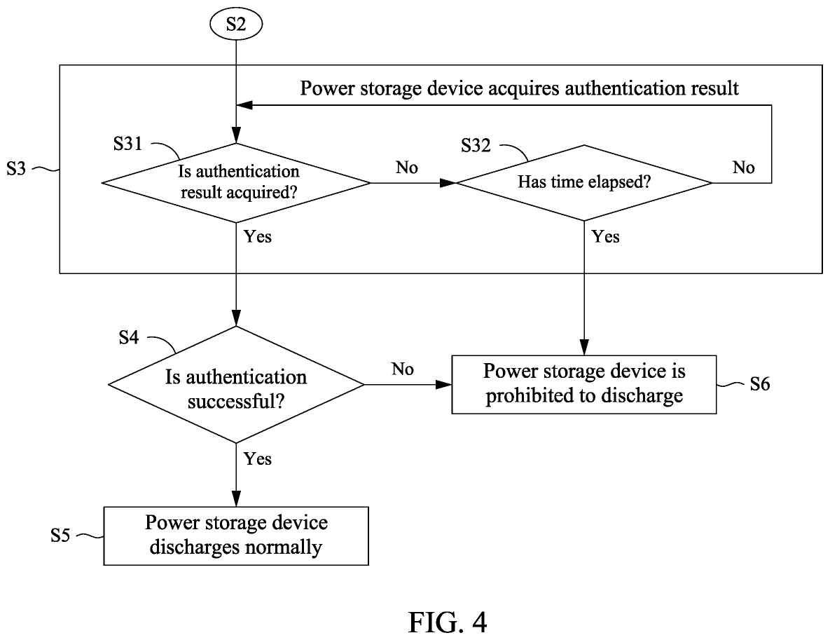

Reference is now made to FIG. 4, where a detail flow chart of step S3 is illustrated. Step S3 may further include steps S31 and S32.

Step S31 describes having the device management unit 140 confirm whether the power storage device 100 has indeed acquired an authentication result. If “yes”, the method continues to step S4 to make a subsequent determination regarding the authentication result. If “no”, the method enters step S32.

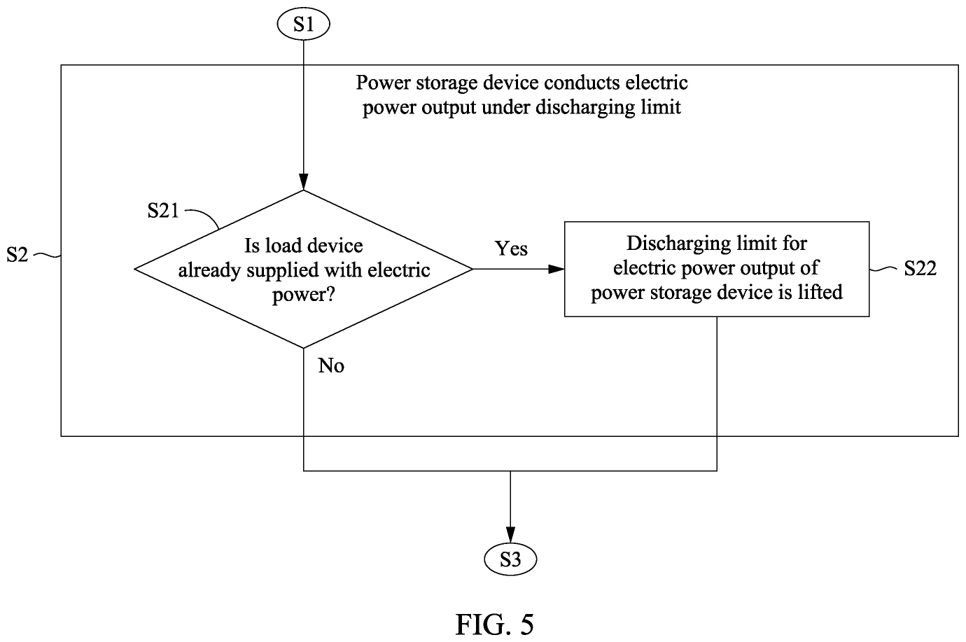

Step S32 describes a situation where the device management unit 140 determines the authentication result has yet been acquired, from which a further confirmation can be made regarding whether a predetermined authentication time has elapsed since the power storage device 100 started the electric power output under the discharging limit. Said authentication time may be the time limit (e.g., 15 seconds) confined by the aforementioned discharging limit; or a predetermined time set up in advance for completing the authentication. Accordingly, the device management unit 140 will continue to wait for acquisition of the authentication result if the time has not exceeded. However, if time has exceeded, the device management unit 140 will determine the authentication as failure and prohibit the power storage device 100 to discharge (step S6). Configuration of the steps in FIG. 5 can prevent the power storage device 100 from continued discharge that leads to self-loss of electric power due to incompleteness on conducting of authentication (e.g., due to failing to receive the authentication information, poor communication environment, inordinate processing time for verification, etc.).

Continue to step S4 of FIG. 2, where step S4 describes the power storage device 100 conducting a corresponding discharge method in accordance with the authentication result acquired. The discharge method in particular refers to a decision by the device management unit 140 regarding whether to prohibit the power storage device 100 from discharging based on determination of the authentication result.

Reference is now made to FIG. 3D, where in the case that the result of step S4 is “yes” (i.e., the authentication results all indicate successful), the device management unit 140 then keeps the switch 142 at ON state and lifts the discharging limit at step S5, thus enabling the electric power output of the power storage device 100 be adjusted to normal discharge (i.e., the electric power being output will not be limited by the power value and/or current value confined by the discharging limit). Here, as indicated by arrow A5, the electric power output by the power storage device 100 will be supplied to all components (including the load components 310) in the system 10.

Reference is now made to FIG. 3E, where in the case that the result of step S4 is “no” (i.e., an arbitrary one of the authentication results indicates failure), the device management unit 140 toggles the switch 142 to OFF state at step S6. Here, as indicated by arrow A6, the device management unit 140 will prohibit the power storage device 100 from outputting electric power to the bridge device 200 and the load device 300.

In additional embodiments, there may exist implementations where said power storage device 100 of the present invention is provided on a load device 300 with backup battery that is intact, or a load device 300 that is supplied by more than one power storage device 100 (i.e., the load device 300 is formed with more than one accommodating space for mounting the power storage device 100). Accordingly, considering situation where the load device 300 is already supplied with electric power when the power storage device 100 is coupled with the load device 300 (i.e., a predetermined electric power output under the discharging limit by the power storage device 100 is not required by the bridge control unit 240 and/or the load control unit 320), the detailed flow of step S2 of the method M may further include steps S21 and S22.

Reference may be made to FIG. 5, where in step S2, the device management unit 140 may first conduct step S21, in response to the connection event sensed at step S1, and determine whether the bridge control unit 240 and/or the load control unit 320 (i.e., load device 300) electrically connected thereto is already under an electrically supplied state. In a preferred embodiment, the determination for electrically supplied state may be based on another notification message received by the device management unit 140 from the bridge control unit 240, or based on other suitable means. Next, if the result for step S21 is “yes” (e.g., the bridge control unit 240 and/or the load control unit 320 is already supplied with electric power by the backup battery; or the load device 300 is already mounted with another power storage device 100 that indicates successful in authentication and is currently supplying electric power under normal discharge), then step S22 can be proceed with the device management unit 140 maintaining the switch 142 at ON state and lifting the discharging limit, so as to conduct later steps of the method M with the power storage device 100 having electric power output adjusted to normal discharge. On the contrary, if the result of step S21 is “no” (e.g., the bridge control unit 240 and/or the load control unit 320 is not supplied with electric power by a backup battery or another power storage device 100), then the device management unit 140 similarly maintains the switch 142 at ON state but enables the power storage device 100 to complete the later steps of the method M using electric power output under the discharging limit.

Based on the above description, the power storage device and the method for discharging the same according to the present invention mainly precondition the power storage device to conduct electric power output under a discharging limit for a control unit on a load device, and only lifts the discharging limit when the authentication(s) between the power storage device and the load device indicates successful. Therefore, if the load device is configured without a backup battery or with a damaged backup battery, the operation of the load control unit can be maintained through the electric power under the discharging limit, thereby achieve mutual authentication with the power storage device, and prevent damage caused to the load device when bearing excessive electric power upon connected to the power storage device.

The above descriptions are merely preferred embodiments for explaining the present invention and are not intended to limit the present invention in any form. Therefore, any modifications or alterations associated with the present invention made under the same spirit shall still be included in the intended scope of the present invention. Therefore, the scope of the present invention should be defined by the scope of the following claims.

What is claimed is:

1. A power storage device, comprising:
a power storage unit configured to store electric power;
an electrical connection unit, configured to electrically connected with the power storage unit and coupled with a load device; and
a device management unit electrically connected with the power storage unit and configured to:
detect a connection event regarding coupling of the electrical connection unit with another electrical connection unit on the load device;
in response to the connection event, output the electric power to the load device through the electrical connection unit under a discharging limit; and
confirm an authentication result between the power storage device and the load device during output of the electric power under the discharging limit.

2. The power storage device of claim 1, wherein the device management unit is further configured to:
lift the discharging limit for output of the electric power if the authentication result indicates to be successful authentication.

3. The power storage device of claim 1, wherein the device management unit is further configured to:
prohibit output of the electric power to the load device if the authentication result indicates to be failed authentication.

4. The power storage device of claim 3, wherein a means for the device management unit confirming the authentication result indicates to be failed authentication comprises confirming the device management unit failing to receive the authentication result within a time limit confined by the discharging limit, and wherein the time limit confines the electric power to be output in a time less than or equal to 15 seconds.

5. The power storage device of claim 1, wherein the discharging limit confines the electric power of the power storage unit to be output at a power value less than or equal to one-twentieth of a maximum output power value of the power storage device; or
the discharging limit confines the electric power of the power storage unit to be output at a current value less than or equal to one-twentieth of a maximum output current value of the power storage device.

6. The power storage device of claim 3, wherein the authentication result is reported back to the device management unit by a bridge control unit, and wherein the bridge control unit is on the load device and is electrically connected with the another electrical connection unit.

7. The power storage device of claim 6, wherein a means for the device management unit confirming the authentication result indicates to be failed authentication comprises one or more of following conditions:
the bridge control unit fails to verify a first authentication information from the device management unit;
the device management unit fails to verify a second authentication information from the bridge control unit;
the bridge control unit fails to verify a third authentication information from a load control unit of the load device;
the load control unit fails to verify a fourth authentication information from the device management unit; and
the device management unit fails to verify a fifth authentication information from the load control unit.

8. A method for discharging a power storage device, comprising:
detecting a connection event regarding coupling of the power storage device with a load device;
in response to the connection event, enabling the power storage device to conduct an electric power output to the load device under a discharging limit; and
confirming an authentication result between the load device and the power storage device during the electric power output under the discharging limit by the power storage device.

9. The method of claim 8, further comprising:
if the authentication result indicates to be successful authentication, lifting the discharging limit of the electric power output by the power storage device.

10. The method of claim 8, further comprising:
if the authentication result indicates to be failed authentication, prohibiting the electric power output by the power storage device.

11. The method of claim 10, wherein a means for confirming the authentication result indicates to be failed authentication comprises confirming the power storage device failing to receive the authentication result within a time limit confined by the discharging limit, and wherein the time limit confines a time for the electric power output to be less than or equal to 15 seconds.

12. The method of claim 8, wherein the discharging limit confines a power value for the electric power output to be less than or equal to one-twentieth of a maximum output power value of the power storage device; or
the discharging limit confines a current value for the electric power output to be less than or equal to one-twentieth of a maximum output current value of the power storage device.

13. The method of claim 10, wherein the authentication result is reported back to the power storage device by a bridge device, and the bridge device is electrically connected to the load device.

14. The method of claim 13, wherein a means for confirming the authentication result indicates to be failed authentication comprises one or more of following conditions:
the bridge device fails to verify a first authentication information from the power storage device;
the power storage device fails to verify a second authentication information from the bridge device;
the bridge device fails to verify a third authentication information from the load device;
the power storage device fails to verify a fourth authentication information from the load device; and
the load device fails to verify a fifth authentication information from the power storage device.

15. The method of claim 8, wherein the step of detecting the connection event regarding the power storage device coupling with the load device comprises:
sensing a closed-circuit condition of an electrical connection between the power storage device and the load device.

16. The method of claim 8, further comprising:
confirming an electrically supplied state of the load device; and
if the electrically supplied state indicates to be supplied with electric power, enabling the power storage device to confirm the authentication result free from the discharging limit.
